(19) United States
(12) Patent Application Publication
(10) Pub. No.: US 2016/0018854 A1
(43) Pub. Date: Jan. 21, 2016

(54) KEYBOARD DEVICE

(71) Applicant: ICHIA TECHNOLOGIES,INC., TAOYUAN COUNTY (TW)

(72) Inventors: SHIH-FU YU, NEW TAIPEI CITY (TW); CHANG-LI LIU, TAOYUAN COUNTY (TW)

(21) Appl. No.: 14/473,097

(22) Filed: Aug. 29, 2014

(30) Foreign Application Priority Data
Jul. 16, 2014 (TW) 103212630

(51) Int. Cl. G06F 1/16

(52) U.S. Cl. CPC G06F 1/1669

(57) ABSTRACT

A keyboard device comprises: a main body, a cover and an interlocking unit. An outer surface of the main body has a keyboard pattern partitioned into protruding keypad structures by a plurality of shallow grooves. The cover extends from one side of the main body, can be bent toward and cover the keyboard pattern, and includes at least one fold line partitioning the cover into a support portion and a carrying portion. Two sides of the support portion respectively connect to the main body and the carrying portion. The carrying portion is free to be bent along the fold line. The holding unit is disposed on the carrying portion. When the holding unit is bent along the fold line and the lower edge of the interlocking unit moves toward the main body and abuts a stopper unit thereon, the holding unit is slanted with respect to the outer surface.

### BACKGROUND OF THE INVENTION

1. Field of the Invention

The present disclosure relates to a keyboard device; in particular, to a keyboard device which supports an electronic device, allows the user to input data into the electronic device, and protects the electronic device.

2. Description of Related Art

With the advancement of information and communication technology, portable tablet electronic devices such as cell phones, smart phones, e-book readers, tablet personal computers, etc. have become essential parts of people's daily lives and work. Portable tablet electronic devices usually have touchscreens, and replace physical keyboards with virtual keypads displayed onscreen. However, in practice, dimensions of the screen of tablet devices are small to increase portability, making the virtual onscreen keyboard difficult to use. Therefore, manufacturers have designed physical keyboards electrically connectable to portable tablet electronic devices. However, these physical keyboards have several problems. For example, when using one of these keyboards, the portable tablet electronic devices need to be independently held upright. Also, the physical keyboard and the portable tablet electronic device are two independent components which need to be carried separately and inconveniently. Hence, the present inventor believes the above mentioned disadvantages can be overcome, and through devoted research combined with application of theory, finally proposes the present disclosure which has a reasonable design and effectively improves upon the above mentioned disadvantages.

### SUMMARY OF THE INVENTION

The object of the present disclosure is to provide a keyboard device for solving problems of conventional keyboard devices for portable electronic devices with touchscreens such as large volume, heavy weight, lack of waterproof ability, and inability to be stored together with the electronic device.

Another object of the present disclosure is to provide a keyboard device, which can be selectively electrically connected to an electronic device and comprises: a main body, a cover and a holding unit. The main body is made of plastic and is integrally formed as one body. An outer surface of the main body has a keyboard pattern. The keyboard pattern is partitioned by a plurality of shallow grooves thereon into protruding keypad structures. The cover extends from one side of the outer surface of the main body and is free to bend toward the keyboard pattern, selectively covering the keyboard pattern. The cover includes at least one fold line partitioning the cover into a support portion and a carrying portion. Two sides of the support portion are respectively connected to the main body and the carrying portion. The carrying portion is bendable along the fold line toward the support portion. The holding unit is disposed on the carrying portion and can hold an electronic device. When the holding unit bends along the fold line toward the main body, a lower edge of the holding unit selectively abuts a stopper unit on the outer surface, such that the holding unit and the outer surface are inclined with respect to each other.

The present disclosure has the following advantages. The electronic device can be disposed in and electrically connected to the holding unit, allowing the user to input signals to the electronic device. Through the bending of the cover, the electronic device disposed in the holding unit can be positioned between and protected by the cover and the main body. In other words, the keyboard device of the present disclosure provides the ability to input signal to the electronic device and the ability to protect the electronic device.

Given that the keypad structures on the keyboard device are formed by heat pressing on the outer surface of the main body, integrally made of plastic as one body, seams do not exist and the keyboard structure is therefore waterproof and light weight.

Given that the cover is bendable, the electronic device disposed on the holding unit can be supported by the cover and disposed at a slanted angle with respect to the horizontal plane. Namely, the keyboard device also props up the electronic device at an inclined angle.

In order to further the understanding regarding the present disclosure, the following embodiments are provided along with illustrations to facilitate the disclosure of the present disclosure.

### BRIEF DESCRIPTION OF THE DRAWINGS

FIG. 1 shows a schematic diagram of the front of a keyboard device with an unbent cover according to the present disclosure;

FIG. 2 shows a schematic diagram of the back of a keyboard device with an unbent cover according to the present disclosure;

FIG. 3 shows a schematic diagram of a keyboard device with a bent cover and a bent flap portion according to the present disclosure;

FIG. 4 shows a schematic diagram of a keyboard device with a bent cover and a bent flap portion engaging each other according to the present disclosure;

FIG. 5 shows a schematic diagram of a keyboard device wherein the lower edge of a holding unit abuts a stopper unit of a main body according to the present disclosure;

FIG. 6 shows a schematic diagram from another perspective of a keyboard device wherein the lower edge of a holding unit abuts a stopper unit of a main body according to the present disclosure;

FIG. 7 shows a schematic diagram of a keyboard device wherein the lower edge of a holding unit abuts a stopper unit protruding from an outer surface of a main body according to the present disclosure;

FIG. 8 shows a schematic diagram from another perspective of a keyboard device wherein the lower edge of a holding unit abuts a stopper unit protruding from an outer surface of a main body according to the present disclosure;

FIG. 9 shows a schematic diagram of a keyboard device wherein a cover is bent toward a main body and covering thereupon according to the present disclosure;

FIG. 10 shows a schematic diagram from another perspective of a keyboard device wherein a cover is bent toward a main body and covering thereupon according to the present disclosure; and

FIG. 11 shows a schematic diagram of a keyboard device wherein a support portion is covering a main body and a carrying portion is covering the support portion.

### DETAILED DESCRIPTION OF THE PREFERRED EMBODIMENTS

The following describes particular embodiments of the present disclosure, and one skilled in the art can apply content disclosed herein and make adjustments thereupon. The present disclosure can be implemented as other embodiments. The present disclosure is not limited to the figures and the dimensions presented therein.

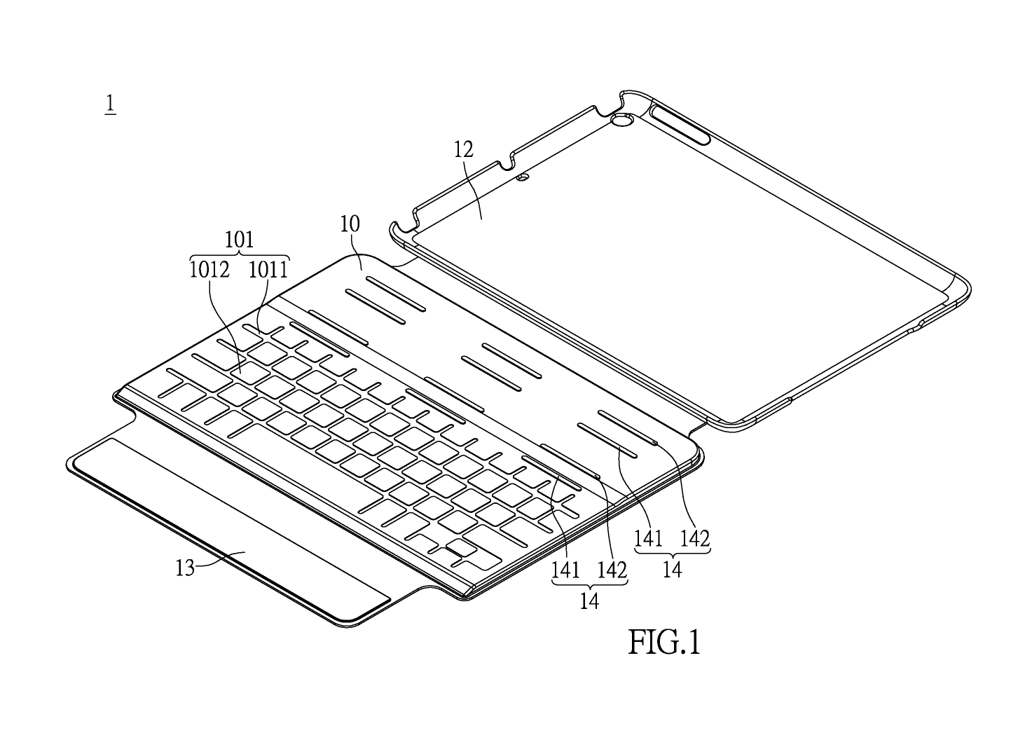

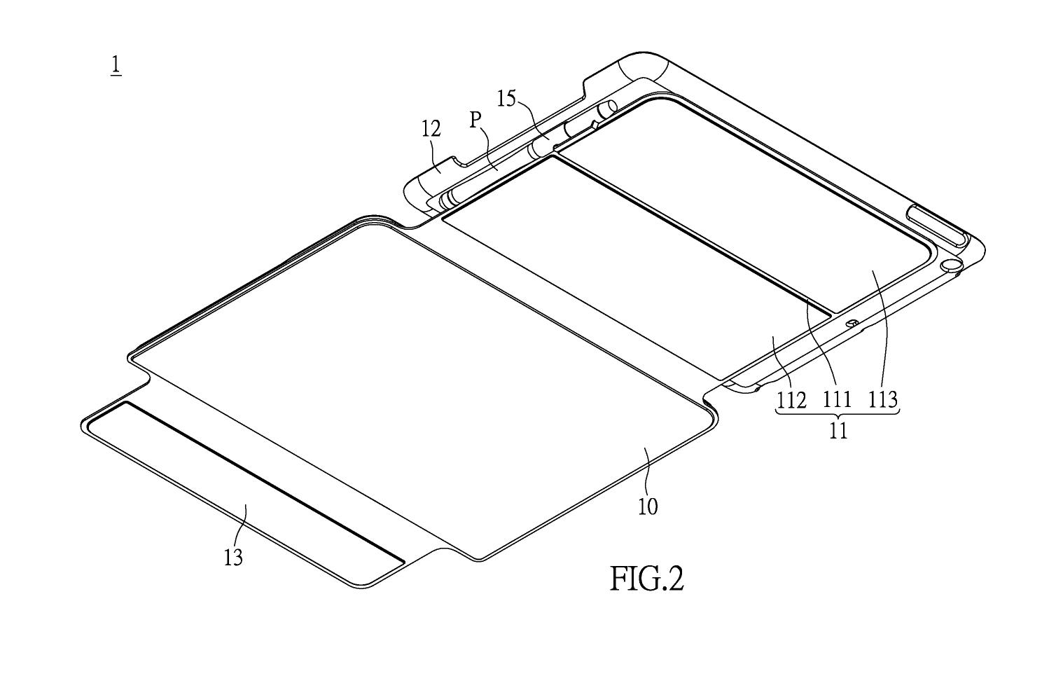

Referring to FIG. 1 and FIG. 2, the keyboard device 1 includes: a main body 10, a cover 11 and a holding unit 12. The main body 10 and the cover 11 are made of plastic and integrally formed as one piece. The cover 11 is free to bend toward the main body 10. The holding unit 12 is disposed on the cover 11 for holding the electronic device. The main body 10 has a keypad circuit module disposed therein (not shown in the figures), such as a membrane keypad circuit module electrically connected to the electronic device through a wireless or wired method, such that the user can input signals to the electronic device through the keyboard device 1.

Specifically, referring to FIG. 1 to FIG. 4, an outer surface of the main body 10 has a keyboard pattern 101. The keyboard pattern 101 is partitioned by a plurality of shallow grooves 1011 thereon into protruding keypad structures 1012. The plastic material can be an elastic material such as polyurethane (PU). The plurality of shallow grooves 1011 can be formed on the outer surface of the main body 10 by heat pressing. In practice, the method is not limited to heat pressing.

The cover 11 extends from one side of the main body 10, and is free to bend toward the main body 10 for selectively covering the keyboard pattern 101. In practice, the cover 11 can also bend toward the side opposite the outer surface formed with the keyboard pattern 101. Additionally, a flap portion 13 can be extended from the side opposite the cover 11. The flap portion 13 is free to bend toward the main body 10.

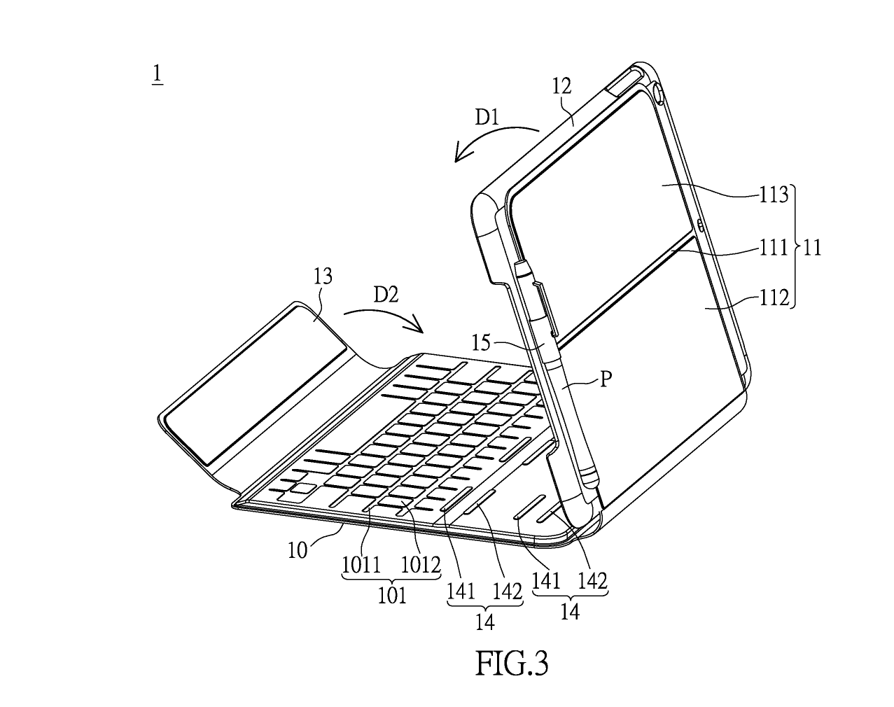

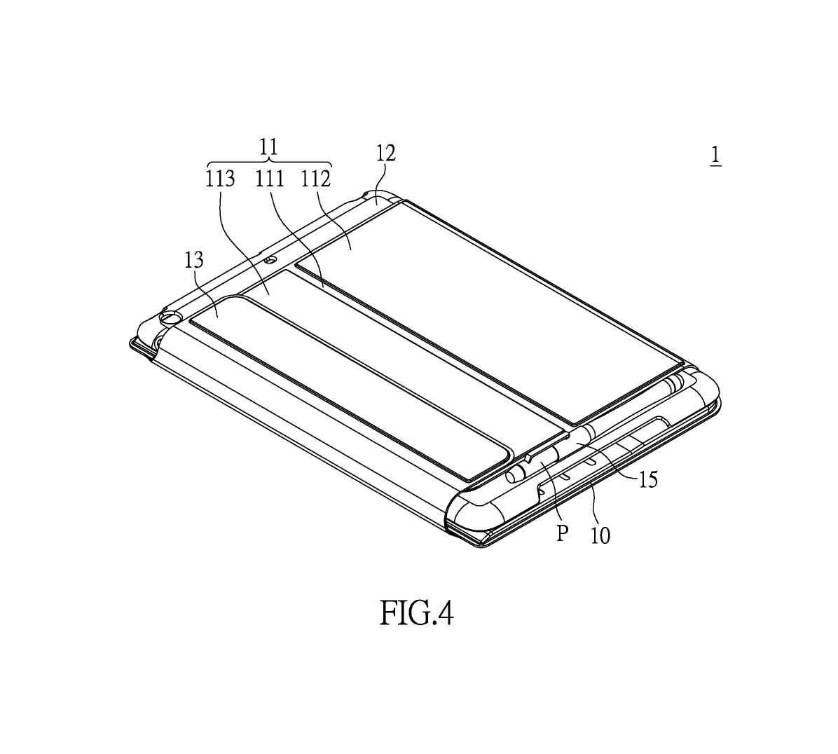

Specifically, as shown in FIG. 3, the cover 11 can be bent in a first direction D1, and the flap portion 13 can be bent in a second direction D2 which is opposite to the first direction D1. As shown in FIG. 4, after the cover 11 and the flap portion 13 have been bent toward and covering the main body 11, the flap portion 13 can cover the cover 11, such that the holding unit 12 on the cover 11 is held between the cover 11 and the main body 10, thereby protecting the electronic device (not shown in the figure). Preferably, the interior of the flap portion 13 or the interior of the part of the cover 11 corresponding to the position of the flap portion 13 has a magnetic material, such that when the flap portion 13 covers the cover 11, they can be secured through magnetic attraction.

Specifically, the size of the holding unit can be designed according to the size of the corresponding electronic device. The keyboard pattern 101 on the outer surface of the main body 10 is preferably smaller or equal to the sectional area of the holding unit 12. Thereby, when the cover 11 is bent toward the main body 10 and the holding unit 12 is positioned between the cover 11 and the main body 10, the keyboard pattern 101 can be completely covered by the holding unit 12 and protected.

Additionally, the cover 11 can have at least one fold line 111. The fold line 111 partitions the cover 11 into a support portion 112 and a carrying portion 113. The carrying portion 113 can bend along the fold line 111 toward the support portion 112. Preferably, the fold line 111 is parallel to the line defined by the connection between the cover 11 and the main body 10. The carrying portion 113 can be bent along the fold line 111 in two directions. Namely, the carrying portion 113 can be bent along the fold line 111 toward two opposite sides of the support portion 112. Specifically, the position of the fold line can be chosen according to need and is not limited to the position shown in the figures of the present embodiment. Preferably, the fold line 111 is positioned at the middle of the cover 11.

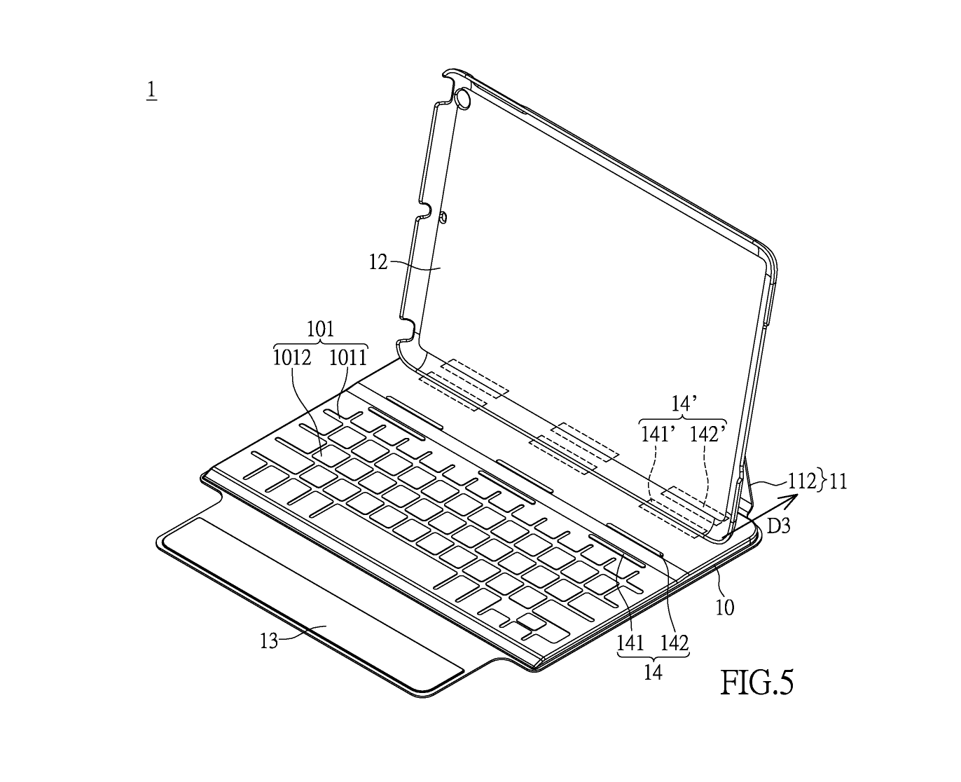

Additionally, at least one stopper unit 14 can be disposed on the outer surface of the main body 10 formed with the keyboard pattern 101. Preferably, the stopper unit 14 is as shown in the figure. The outer surface of the main body 10 has two stopper units 14 arranged at an interval. Each stopper unit 14 can include a first stopper unit 141 and a second stopper unit 142. The first stopper unit 141 is closer to the keyboard pattern 101, and the second stopper unit 142 is closer to the connection between the main body 10 and the cover 11. The distance between any of the first stopper units 141 and the corresponding second stopper unit 142 is smaller than the distance between stopper units 14. As shown in FIG. 5, a stopper unit can be for example protruding structures on the outer surface of the main body 10 (labeled 14 in the figure), or internally disposed magnetic material (labeled 14′). Of course, the stopper unit 14 can include protruding structures and internally disposed magnetic material. The quantity and method of arrangement of the stopper units 14 shown in the figures of the present disclosure are only examples and can be modified upon according to need.

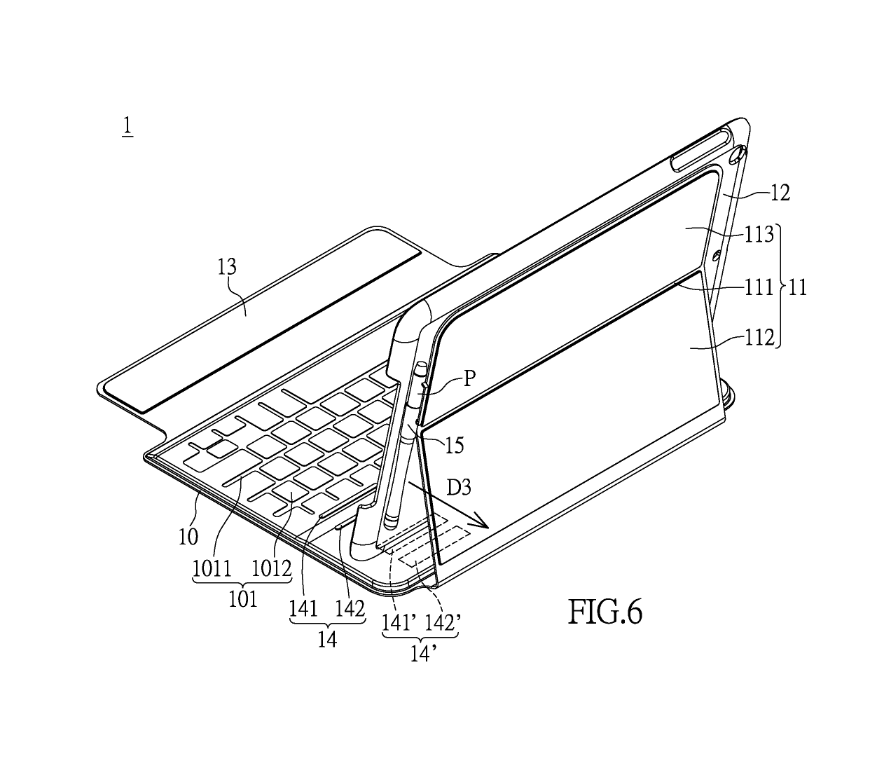

As shown in FIG. 3, FIG. 5 and FIG. 6, when the support portion 112 of the cover 11 is bent in the first direction D1 (toward the main body 10) and the carrying portion 113 is bent in the second direction D2 opposite the first direction D1, the holding unit 12 is adjacent to the lower edge of the main body 10 and abuts the first stopper unit 141′ of the stopper unit 14′ (magnetic material disposed inside the main body 10) on the outer surface of the main body 10. Thereby, the electronic device disposed on the holding unit 12 can be disposed at a slanted angle with respect to the main body 10, such that the electronic device is disposed on the main body 10 slantedly. The user can conveniently use the keypad structures 1012 on the outer surface of the main body 10. Of particular note, in practice, the lower edge of the holding unit 12 has magnetic material corresponding to the stopper unit 14′ for stopping the holding unit 12 at the stopper unit 14′.

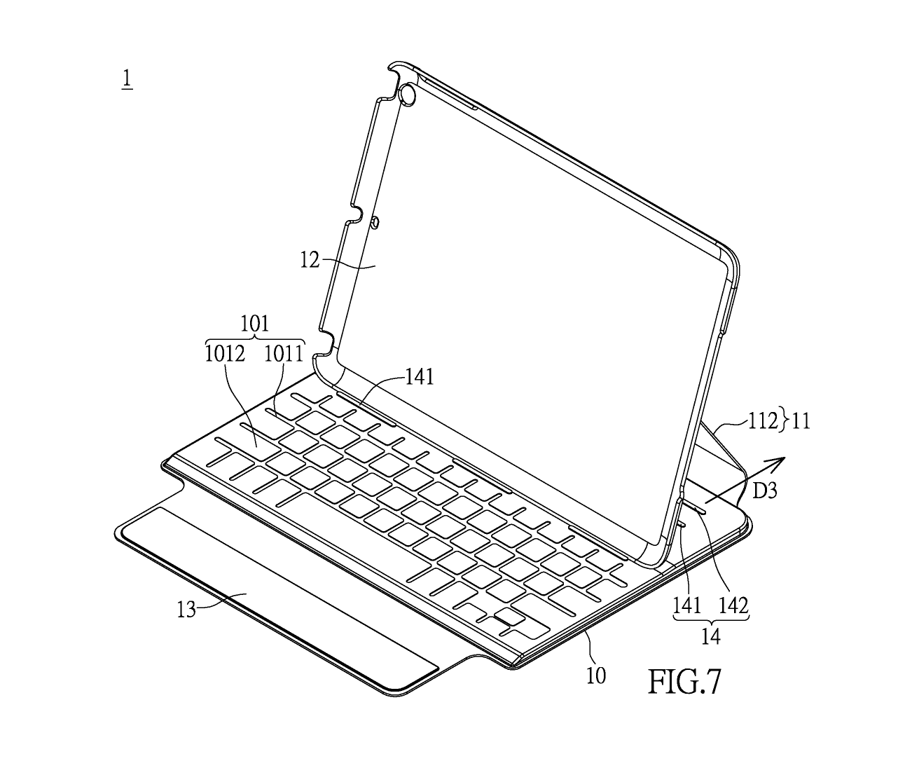

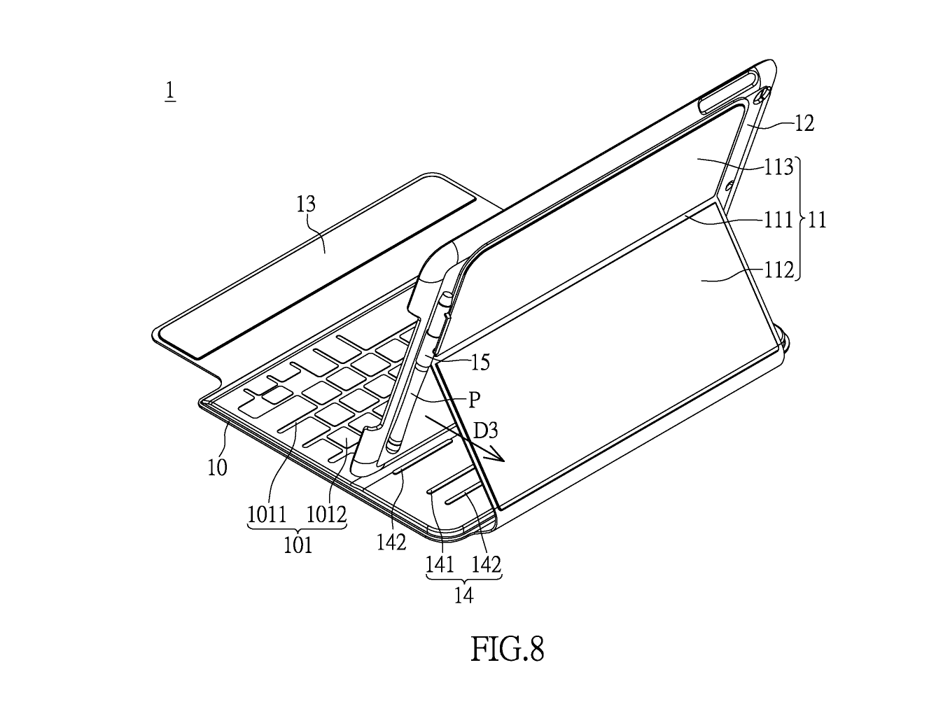

As shown in FIG. 7 and FIG. 8, the interlocking holding unit 12 can selectively abut the stopper unit 14 or the stopper unit 14′ arranged at different positions on the main body, for different angles of inclination, thereby allowing the user to choose between different angles of inclination. Of course, in other implementations, additional stopper units can be added according to need, such that the user has more angles of inclination to choose from. Of particular note, in practice, the form of the stopper unit (for example the two forms shown in FIG. 5 and FIG. 6, and the form shown in FIG. 7 and FIG. 8) is not limited to the form disclosed in the figures.

Referring again to FIG. 7 and FIG. 8, of particular note, when the lower edge of the holding unit 12 abuts the first stopper unit 141 such that the electronic device (not shown in the figure) is disposed at a second inclined state (as opposed to a first inclined state shown in FIG. 5 and FIG. 6), the electronic device and the holding unit 12 can be pushed by the user during operation of the keypad structures 1012 or operation of the electronic device disposed at the holding unit 12, and move in a third direction D3. The lower edge of the interlocking unit 12 can cross over the first stopper unit 141 and slide about on the outer surface of the main body 10, and then abut the other stopper unit 14 closer to the connection between the main body 10 and the cover 11, thereby changing the inclined state of the holding unit 12 with respect to the main body (changing from the second inclined state to the first inclined state), creating inconvenience for the user. Therefore, a second stopper unit 142 is disposed proximal to each of the first stopper units 141 for abutting the lower edge of the holding unit 12 and preventing the holding unit 12 from moving in the third direction D3, such that the holding unit 12 does not move past the first stopper unit 141 and onto the other stopper unit 14.

Similarly, as shown in FIG. 5 and FIG. 6, if the holding unit 12 abuts the first blocker unit 141′ close to the connection between the main body 10 and the cover 11 and is pushed by the user, the second stopper unit 142′ stops the stopper unit 12 from moving in the third direction D3 and possibly causing problems of falling over. In other words, the second stopper units 142, 142′ disposed proximal to the first stopper units 141, 141′ effectively stop the holding unit 12 from changing inclined states or falling over when the user operates the electronic device or the keypad structures 101.

Additionally, in practice, the angle of inclination of the holding unit 12 with respect to the main body 10 can be adjusted by adjusting the position of the fold line 111 of the cover 11. The position of the fold line on the cover 11 determines the position of support between the holding unit 12 and the cover 11, consequently determining the forces exerted respectively by the support portion 112 of the cover 11 and the stopper unit 14 of the main body 10 on the holding unit 12 at rest. The force the stopper unit 14 needs to exert on the holding unit 12 to keep the holding unit 12 from sliding determines the options for the forms of the stopper unit 14. For example, a protrusion on the outer surface of the main body 10 provides greater force for support, and magnetic material embedded inside the main body 10 provides a smaller force for support. The fold line 111 of the cover 11 may be disposed at the middle of the main body 11, such that the stopper unit 14 closer to the connection between the main body 10 and the cover 11 may be embedded magnetic material.

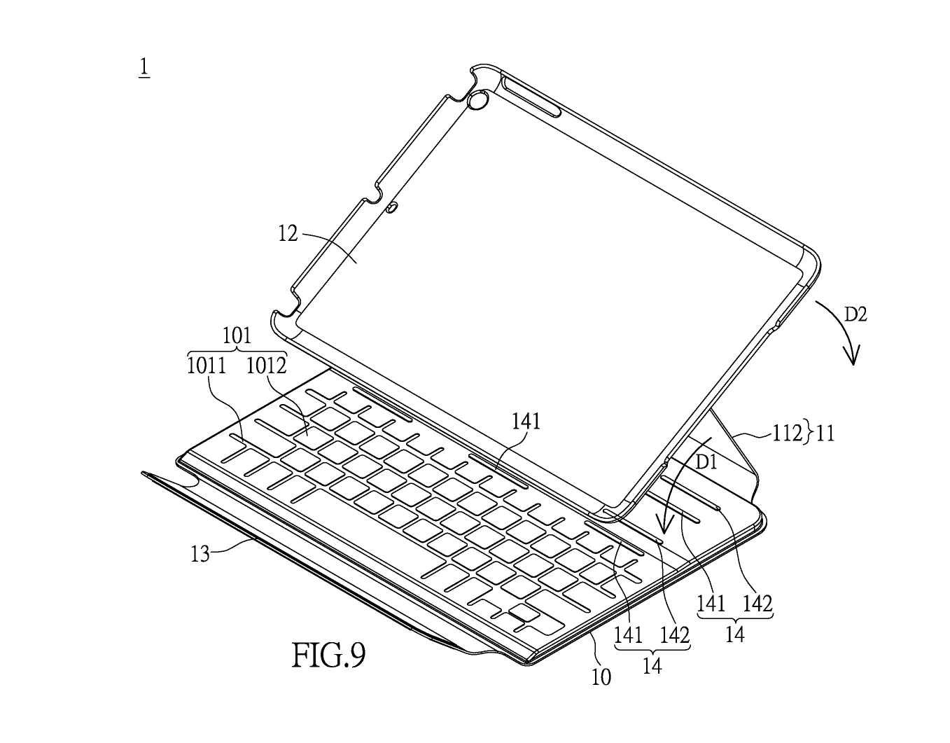

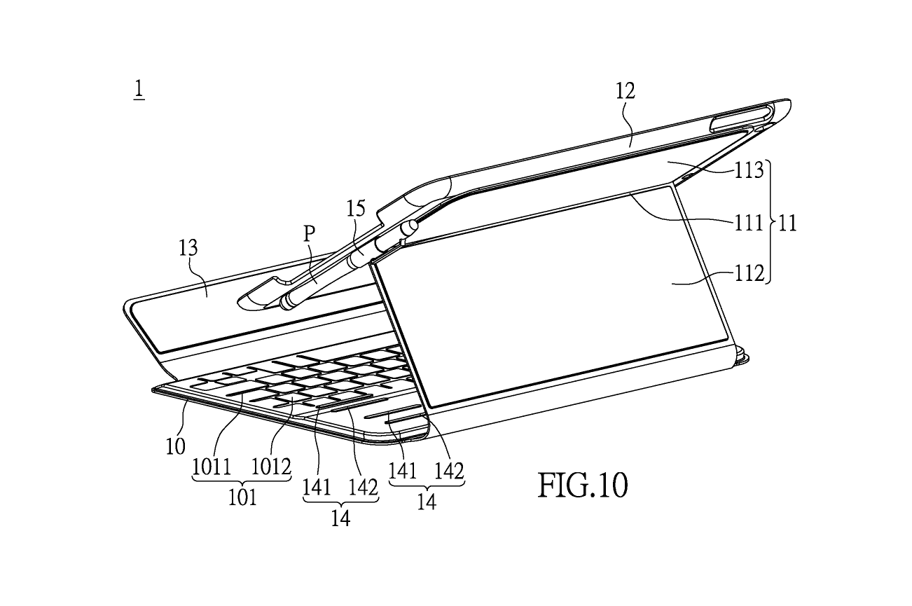

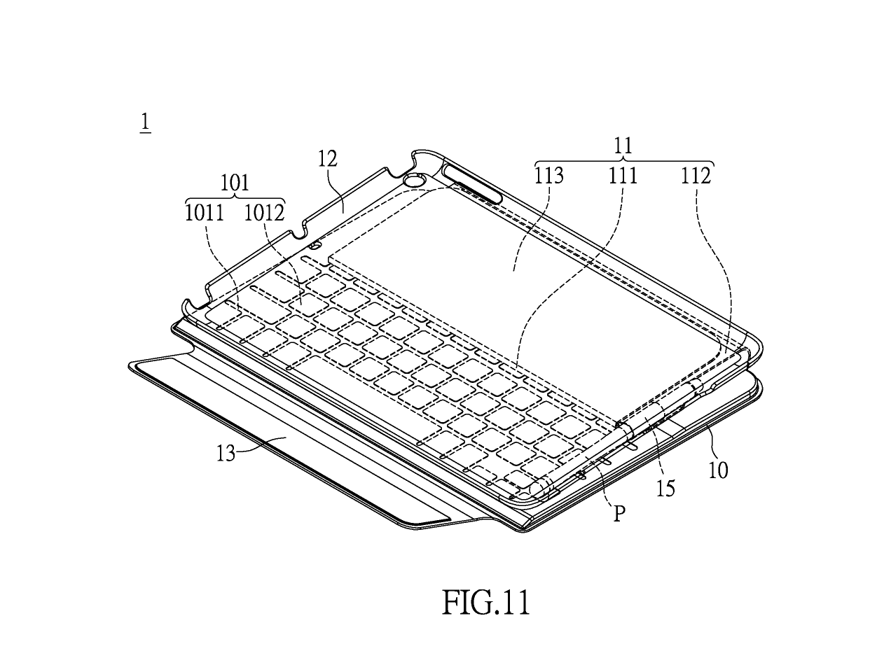

As shown in FIG. 9 to FIG. 11, in another implementation of the present disclosure, the support portion 112 of the cover 11 can be bent in the first direction (toward the main body 10) and covers the main body 10, and the carrying portion 113 is bent in the second direction D2 (opposite the first direction D1) and covers the support portion 112, such that the holding unit 12 can lie on top of the main body 10 for the user to directly operate the electronic device. Namely, when the user is not using the keypad structures 1012 on the main body 10, the holding unit 12 can be made to lie on top of the main body 10 by bending the cover 11, such that the user can directly operate the electronic device.

Additionally, of particular note, in practice, the electronic device may be a portable touchscreen device such as a tablet pc, smart phone, etc. which can be controlled by fingers or stylus pens. Therefore, as shown in FIG. 4, one side of the carrying portion 113 has an elastic unit 15 for accommodating an input device P (e.g. stylus pen, etc.). For example, the elastic unit 15 can be an elastic sleeve having a through hole such that the user can insert the input device P (e.g. stylus pen) therein. Of particular note, as shown in FIG. 6, the position of the elastic unit 15 is preferably on a side of the carrying portion 113 and proximal to the fold line 111, such that when the support portion 112 is bent toward the main body 10, the stylus pen inserted in the elastic unit 15 moves along with the carrying portion 113 and the holding unit 12 disposed thereon so as to not affect the bending of the cover 11.

The descriptions illustrated supra set forth simply the preferred embodiments of the present disclosure; however, the characteristics of the present disclosure are by no means restricted thereto. All changes, alterations, or modifications conveniently considered by those skilled in the art are deemed to be encompassed within the scope of the present disclosure delineated by the following claims.

What is claimed is:

1. A keyboard device, selectively electrically connected to an electronic device, comprising:
a main body, made of plastic material and integrally formed as one body, wherein an outer surface of the main body has a keyboard pattern, the keyboard pattern includes a plurality of shallow grooves, and the shallow grooves partitions the keyboard pattern into protruding keypad structures;
a cover extended from one side of the outer surface of the main body, free to bend toward and cover the keyboard pattern, and having at least one fold line, wherein the fold line partitions the cover into a support portion and a carrying portion, two sides of the support portion respectively connect to the main body and the carrying portion, and the carrying portion is free to bend toward the support portion along the fold line; and
a holding unit disposed on the carrying portion for holding an electronic device; wherein
when the holding unit is bent along the fold line and the lower edge of the holding unit moves toward the main body, the lower edge of the holding unit selectively abuts at least one stopper unit of the main body and the holding unit is slanted with respect to the outer surface.

2. The keyboard device according to claim 1, the outer surface has at least two stopper units arranged at an interval.

3. The keyboard device according to claim 2, wherein each of the stopper units includes a first stopper unit and a second stopper unit, each of the first stopper units and the respective second stopper unit are arranged close to each other, each of the first stopper units is more proximal to the keyboard pattern than the respective second stopper unit is, and each of the second stopper units is more proximal to the connection between the main body and the cover than the respective first stopper unit is.

4. The keyboard device according to claim 3, wherein the stopper units are protruding members on the outer surface, or magnetic material embedded inside the main body.

5. The keyboard device according to claim 4, wherein the stopper unit more proximal to the cover is magnetic material embedded in the main body or protruding members on the outer surface, and the stopper unit more distal from the cover is magnetic material embedded in the main body or protruding members on the outer surface.

6. The keyboard device according to claim 1, wherein when the lower edge of the holding unit abuts one of the stopper units, the carrying portion is bent in a first direction and the support portion is bent in a second direction opposite to the first direction.

7. The keyboard device according to claim 6, wherein the fold line is positioned at the middle of the cover, when the support portion is bent in the second direction and covers the main body and the carrying portion is bent in the first direction and covers the support portion, the holding unit lies on top of the main body, and the sectional area of the holding unit is greater than or equal to the area of the outer surface of the main body.

8. The keyboard device according to claim 1, further comprising an elastic unit disposed at one side of the carrying portion for accommodating an input device.

9. The keyboard device according to claim 1 wherein the main body further includes a flap portion extended from one side of the main body.

10. The keyboard device according to claim 9, wherein when the cover is bent toward the main body and covers the keyboard pattern, the flap portion is free to be bent and disposed on the carrying portion, and a magnetic material is disposed inside the flap portion or the part of the cover corresponding to the position of the flap portion.
